(19) United States
(12) Patent Application Publication
(10) Pub. No.: US 2004/0163264 A1
(43) Pub. Date: Aug. 26, 2004

(54) Hand saw

(76) Inventor: John C. Simonz, Hartford, WI (US)

Correspondence Address: David B. Smith, Michael Best & Friedrich LLP, 100 East Wisconsin Avenue, Milwaukee, WI, 53202-4108, US

(21) Appl. No.: 10/371,075

(22) Filed: Feb. 21, 2003

(51) Int. Cl. B27B 21/00; B23D 51/01

(52) U.S. Cl. 30/517

(57) ABSTRACT

A hand saw and a kit. In some aspects, the manual hand saw includes a handle and a quick release blade clamp assembly connected to the handle and adapted to selectively attach a blade to the handle. In some aspects, the manual hand saw includes a handle and a handle extension connectable to the handle. In some aspects, the kit includes a hand saw, a reciprocating saw blade usable with a power-operated reciprocating saw, a putty knife, and a carpet blade. In some aspects, the kit includes a hand saw, a first blade supportable by the hand saw, the first blade being a first type of blade, and a second blade supportable by the hand saw, the second blade being a second type of blade.

### FIELD OF THE INVENTION

The present invention relates to hand saws and, more particularly, to a manual hand saw.

### BACKGROUND OF THE INVENTION

A manual hand saw includes a handle and a saw blade connected to the handle. In some manual hand saws, the saw blade is removably connected to the handle by one or more fasteners or screws. In other manual hand saws, the saw blade is permanently or integrally connected to the handle. In some manual hand saws, the handle is externally threaded for securing a handle extension to the handle by means of an additional coupling.

### SUMMARY OF THE INVENTION

In some manual hand saws, blade removal and replacement is difficult and time consuming. Also, if the fastener(s) are lost, the manual hand saw cannot be reassembled properly, and the manual hand saw will be inoperable.

Existing manual hand saws with replaceable blades are typically usable with only one type of blade. Manual hand saws with an integral blade must be discarded after the one blade breaks or wears-out.

In some manual hand saws, additional coupling components are required to couple a handle extension to the manual hand saw. Such additional coupling components can be easily misplaced, lost or damaged, any of which would prevent the handle extension from being coupled to the manual hand saw. Some manual hand saws can only be coupled to a single handle extension which is manufactured solely for the purpose of being coupled to and providing a handle extension for the manual hand saw.

The present invention provides a hand saw and a kit which substantially alleviates one or more independent problems with existing hand saws. In some constructions and in some aspects, the invention provides a manual hand saw including a quick release blade clamp assembly facilitating quick and easy replacement of a blade. Also, in some constructions and in some aspects, the invention provides a hand saw operable with a variety of types of blades. In addition, in some constructions and in some aspects, the invention provides a hand saw requiring no additional coupling components for coupling a handle extension to the hand saw. Further, in some constructions and in some aspects, the invention provides a hand saw connectable to a variety of handle extensions.

More particularly, the invention provides a manual hand saw including a handle and a quick release blade clamp assembly connected to the handle and adapted to selectively attach a saw blade to the handle. The blade clamp assembly may include a locking member movable relative to the handle between a locked position, in which the locking member engages the blade, and an unlocked position, in which the locking member does not engage the blade. The blade clamp assembly may also include an actuating member operatively associated with the locking member and movable relative to the handle between an engaged position, in which the locking member is in the locked position, and a disengaged position, in which the locking member is in the unlocked position.

The actuating member may be rotatable relative to the handle between the engaged position and the disengaged position. The actuating member may allow the locking member to move from the locked position to the unlocked position when the actuating member is moved from the engaged position to the disengaged position. The actuating member may move the locking member from the locked position to the unlocked position when the actuating member is moved from the engaged position to the disengaged position. The actuating member may move the locking member from the unlocked position to the locked position when the actuating member is moved from the disengaged position to the engaged position. The actuating member may allow the locking member to move from the unlocked position to the locked position when the actuating member is moved from the disengaged position to the engaged position.

Movement of the actuating member from the disengaged position to the engaged position may result in forced movement of the locking member from the unlocked position to the locked position, and movement of the actuating member from the engaged position to the disengaged position may result in forced movement of the locking member from the locked position to the unlocked position. The hand saw may define a longitudinal axis, the actuating member being rotatable about the axis. The actuating member may include an outer cam surface and an inner cam surface, and the locking member may include an outer follower surface drivable by the outer cam surface and an inner follower surface drivable by the inner cam surface. The actuating member may include an outer gripping surface having a unidirectional pattern that facilitates gripping and moving the actuating member toward the disengaged position.

The blade clamp assembly may also include a biasing member interconnected with the actuating member for biasing the actuating member toward the engaged position. The biasing member may be a spring. The biasing member may be a torsional coil spring. The blade clamp assembly may also include a washer positioned against a portion of the biasing member.

The blade clamp assembly may also include a cover enclosing a substantial portion of the biasing member, and wherein the actuating member may engage the cover to form a seal. The blade clamp assembly may also include a cover enclosing a substantial portion of the biasing member and a housing enclosing a substantial portion of the actuating member, the housing may engage the cover to form a seal, and wherein the actuating member may engage the cover at a junction and the housing may enclose at least part of the junction.

The handle may include a rear end and a front end and may define an opening extending from the rear end toward the front end. Threads may be defined within the opening and may be threadably engageable with complementary threads on a handle extension to connect the handle extension and the handle.

The handle may define threads, the threads may be threadably engageable with complementary threads on a handle extension to connect the handle extension and the handle. The handle may include a rear end and a front end and may define an opening extending from the rear end toward the front end, the threads of the handle may be defined within the opening.

The saw blade may be a reciprocating saw blade usable with a power-operated reciprocating saw. The saw blade may be, for example, a putty knife, a carpet blade, a file, etc.

Also, the invention provides a manual hand saw including a handle having an outer surface and defining an opening extending from the outer surface, the opening having a first handle portion adjacent to the outer surface having a first diameter and a second handle portion having a second diameter less than the first diameter, the handle being operable to support a blade, and a handle extension having a first extension portion engageable with the first handle portion and a second extension portion engageable with the second handle portion, the handle being connectable to the handle extension. The manual hand saw may include threads defined in at least the second handle portion of the opening and complementary threads on at least the second extension portion of the handle extension. The manual hand saw may also include a quick release blade clamp assembly connected to the handle and adapted to selectively attach the blade to the handle.

In addition, the invention provides a kit including a manual hand saw, a reciprocating saw blade usable with a power-operated reciprocating saw, a putty knife, and a carpet blade, and the reciprocating saw blade, the putty knife, and carpet blade are interchangeably connectable to the hand saw. The hand saw may include a handle and a quick release blade clamp assembly connected to the handle for selectively attaching one of the reciprocating saw blade, putty knife, and carpet blade to the handle.

Further, the invention provides a kit including a manual hand saw, a first blade selectively supportable by the hand saw, the first blade being a first type of blade, and a second blade selectively supportable by the hand saw, the second blade being a second type of blade. The first type of blade may be a reciprocating saw blade useable with a power-operated reciprocating saw, and the second type of blade may be a putty knife. The first type of blade may be a reciprocating saw blade, and the second type of blade may be a carpet blade. The first type of blade may be a reciprocating saw blade, and the second type of blade may be a file. The first type of blade may be a putty knife, and the second type of blade may be a carpet blade. The first type of blade may be a putty knife, and the second type of blade may be a file. The first type of blade may be a carpet blade, and the second type of blade may be a file.

One independent advantage of the present invention is that, in some aspects, blade removal and replacement is quick and easy.

Another independent advantage of the present invention is that, in some aspects, the hand saw does not require independent fasteners to attach a blade to the hand saw.

A further independent advantage of the present invention is that, in some aspects, the hand saw is usable with a variety of types of blades.

Yet another independent advantage of the present invention is that, in some aspects, the hand saw does not require additional coupling components to couple a handle extension to the hand saw.

Another independent advantage of the present invention is that, in some aspects, the hand saw can be coupled to a variety of types of handle extensions.

Other independent features and independent advantages of the present invention will become apparent to those skilled in the art upon review of the following detailed description, claims and drawings.

### BRIEF DESCRIPTION OF THE DRAWINGS

FIG. 1 is front perspective view of a hand saw embodying aspects of the invention.

FIG. 2 is an exploded partial cross-sectional side view of the hand saw shown in FIG. 1.

FIG. 3 is an exploded front perspective view of a kit embodying aspects of the invention including the hand saw shown in FIG. 1.

FIG. 4 is an exploded front perspective view of a first construction of a blade clamp assembly of the hand saw shown in FIGS. 1 and 2.

FIG. 5 is a rear perspective view of a front cam member of the blade clamp assembly shown in FIG. 4.

FIG. 6 is a rear view of the front cam member shown in FIG. 5.

FIG. 7 is a front perspective view of a rear cam member of the blade clamp assembly shown in FIG. 4.

FIG. 8 is a front view of the rear cam member shown in FIG. 7.

FIG. 9 is a cross-sectional view taken along line A-A in FIG. 2 of the first construction of the blade clamp assembly with the assembly in a engaged condition.

FIG. 10 is the cross-sectional view of FIG. 9 with the assembly in a disengaged condition.

FIG. 11 is a cross-sectional view taken along line B-B in FIG. 2 of the first construction of the blade clamp assembly with the assembly in the engaged condition.

FIG. 12 is the cross-sectional view of FIG. 11 with the assembly in the disengaged condition.

FIG. 13 is a cross-sectional view taken along line C-C in FIG. 9 with a blade connected to the blade clamp assembly.

FIG. 14 is an exploded front perspective view of a second construction of the blade clamp assembly of the hand saw shown in FIGS. 1 and 2.

FIG. 15 is a front view of the blade clamp assembly shown in FIG. 14.

FIG. 16 is a cross-sectional view taken along line D-D in FIG. 15.

FIG. 17 is a cross-sectional view taken along line A-A in FIG. 2 of the second construction of the blade clamp assembly with the assembly in the disengaged condition.

FIG. 18 is a cross-sectional view taken along line B-B in FIG. 2 of the second construction of the blade clamp assembly with the assembly in the engaged condition.

FIG. 19 is the cross-sectional view of FIG. 18 with the assembly in the disengaged condition.

FIG. 20 is a front view of a pin of the blade clamp assembly shown in FIG. 14.

FIG. 21 is a front perspective view of a cam collar of the blade clamp assembly shown in FIG. 14.

FIG. 22 is a rear perspective view of the cam collar shown in FIG. 21.

FIG. 23 is a side view of a spring cover of the blade clamp assembly shown in FIG. 14.

FIG. 24 is a front view of the spring cover shown in FIG. 23.

FIG. 25 is a rear perspective view of a collar housing of the blade clamp assembly shown in FIG. 14.

FIG. 26 is a side view of the collar housing shown in FIG. 25.

FIG. 27 is a cross-sectional view taken along line 27-27 in FIG. 26.

FIG. 28 is an exploded front perspective view of a third construction of the blade clamp assembly of the hand saw shown in FIGS. 1 and 2.

FIG. 29 is a front perspective view of a nose portion of the blade clamp assembly shown in FIG. 28.

FIG. 30 is a cross-sectional view taken along line A-A in FIG. 2 of the third construction of the blade clamp assembly with the assembly in the engaged condition.

FIG. 31 is a cross-sectional view taken along line 31-31 in FIG. 30.

FIG. 32 is a cross-sectional view taken along line 32-32 in FIG. 31.

FIG. 33 is a cross-sectional view taken along line A-A in FIG. 2 of a fourth construction of the blade clamp assembly of the hand saw shown in FIGS. 1 and 2.

FIG. 34 is a cross-sectional view taken along line 34-34 in FIG. 33.

FIG. 35 is a cross-sectional view taken along line A-A in FIG. 2 of a fifth construction of the blade clamp assembly of the hand saw shown in FIGS. 1 and 2.

FIG. 36 is a cross-sectional view taken along line 36-36 in FIG. 35.

Before at least one embodiment of the invention is explained in detail, it is to be understood that the invention is not limited in its application to the details of the constructions and arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION

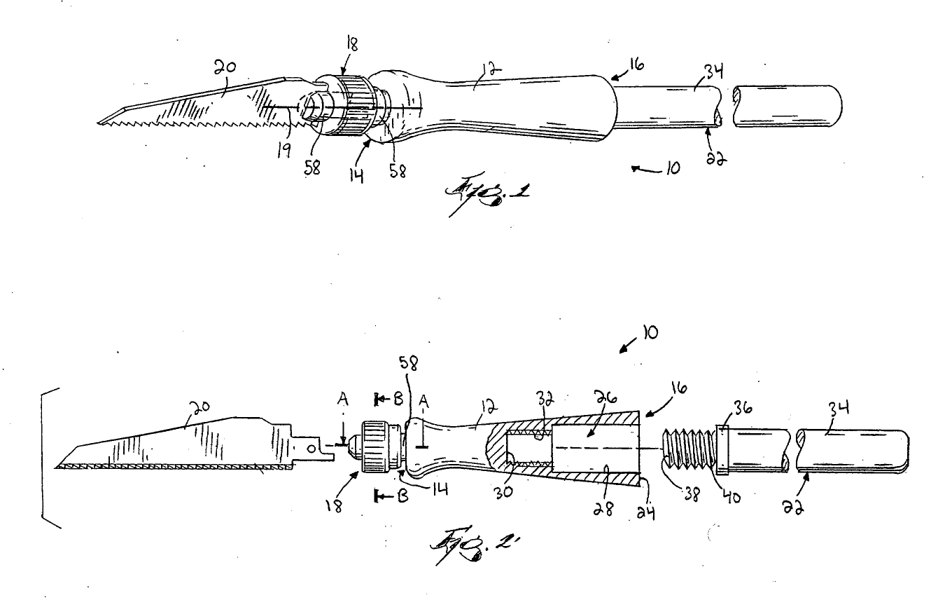

FIG. 1 illustrates a hand saw 10 embodying aspects of the present invention. In some aspects, the hand saw 10 is a manual hand saw and includes a handle 12 having a front end 14 and a rear end 16. In the illustrated construction, the handle 12 is contoured to facilitate comfortable grasping by a user. It should be understood that, in other constructions and for some aspects of the invention, the handle 12 can be contoured in any manner.

In some aspects, the hand saw 10 includes a support portion or quick release blade clamp assembly 18 supported on the front end 14 along an axis 19 extending through a center of the hand saw 10. A blade 20 is selectively couplable to the blade clamp assembly 18.

In some aspects, a handle extension 22 is selectively couplable to the handle 12 at the rear end 16. In the illustrated construction, the handle extension is substantially cylindrical. It should be understood that, in other constructions (not shown) and for some aspects of the invention, the handle extension 22 can be shaped in any manner and have any length.

As shown in FIG. 2, the handle 12 includes an outer surface 24 at the rear end 16, and an opening 26 is defined in the handle 12 extending from the rear end 16 toward the front end 14. The opening 26 includes a first portion 28 adjacent to the outer surface 24 and a second portion 30. In the illustrated construction, the first portion 28 has a first diameter, and the second portion 30 has a second diameter smaller than the first diameter. It should be understood that, in other constructions (not shown) and for some aspects of the invention, the first diameter and the second diameter can be the same diameter, or the second diameter can be larger than the first diameter.

Threads 32 are defined within the opening 26 to threadably engage the handle extension 22 to connect the handle extension 22 to the handle 12 (as discussed below). In the illustrated construction, the threads 32 are defined in the second portion 30 of the opening 26. It should be understood that, in other constructions (not shown) and for some aspects of the invention, the threads 32 can be defined differently in the opening 26, such as, for example, in both the first portion 28 and the second portion 30 of the opening 26, in the first portion 28 of the opening 26 alone, or partially in the first portion 28 and partially in the second portion 30 of the opening 26.

The handle extension 22 includes a grasping member 34, a first portion 36, and a second portion 38. In the illustrated construction, the first portion 36 has a first diameter and the second portion 38 has a second diameter smaller than the first diameter. It should be understood that, in other constructions (not shown) and for some aspects of the invention, the first diameter and the second diameter can be the same diameter or the second diameter can be larger than the first diameter.

Preferably, the diameter of the first portion 28 and the diameter of the first portion 36 are substantially the same diameter so that they are engageable. Also, the diameter of the second portion 30 and the diameter of the second portion 38 are substantially the same diameter so that they are engageable. It should be understood that, in other constructions (not shown) and for some aspects of the invention, the first portions 28, 36 can have different diameters and/or the second portions 30, 38 can have different diameters.

Threads 40, complementary to the threads 32 defined in the opening 26, are defined on the handle extension 22. The threads 32, 40 are threadably engageable to connect the handle extension 22 to the handle 12. In the illustrated construction, the threads 40 are defined on the second portion 38 of the handle extension 22. It should be understood that, in other constructions (not shown) and for some aspects of the invention, the threads 40 can be defined differently in the handle extension 22, such as, for example, on both the first portion 36 and the second portion 38 of the handle extension 22, on the first portion 36 of the handle extension 22 alone, or partially on the first portion 36 and partially on the second portion 38 of the handle extension 22.

Preferably, the threads 32 of the opening 26 and the threads 40 of the handle extension 22 are defined by complementary portions with respect to each other. In some aspects, the threads 32 and 40 defined in the opening 26 and on the handle extension 22, respectively, are ACME type threads. ACME type threads are a type of threading commonly used with many items, such as, for example, broom handles. By having, in some constructions and in some aspects, ACME type threads 32 defined in the opening 26, the handle 12 can threadably engage many items other than a handle extension 22 manufactured specifically for the hand saw 10.

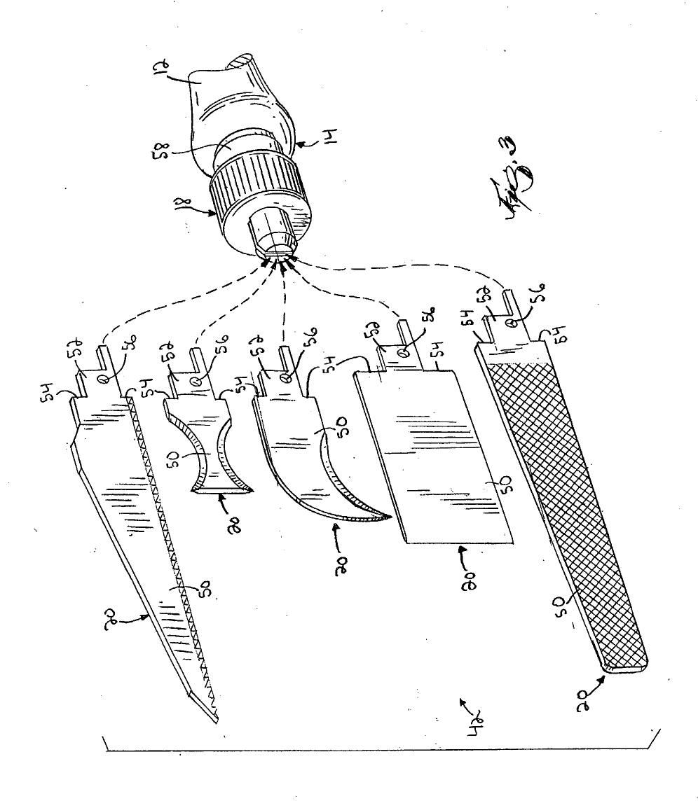

As shown in FIG. 3, a set of several types of blades 42 are useable with the hand saw 10 and may be provided as a kit with or without the hand saw 10. The set of blades 42 can include any number and any type of blade 20, such as, for example, a reciprocating saw blade usable with a power-operated reciprocating saw (not shown), a roofer knife, a carpet blade, a putty knife, a file, etc. One of the blades 20 of the set of blades 42 can be selectively connected to the handle 12 at a time via, in some constructions and in some aspects, the blade clamp assembly 18.

In the illustrated construction, each blade 20 includes a body portion 50, a tang 52, and two shoulder portions 54 that form the transition from the body portion 50 to the tang 52. The body portion 50 of each blade 20 is shaped according to the function it performs. For example, the saw blade includes a plurality of cutting teeth defined in an edge for cutting a workpiece. In another example, the file includes a plurality of filing teeth defined in at least one side for filing a workpiece. The tang 52 of each blade 20 is substantially identical and has an aperture 56 defined therethrough. The tang 52 of each blade 20 is selectively engageable with, in some constructions and some aspects, the blade clamp assembly 18 to selectively connect the respective blade 20 to the handle 12.

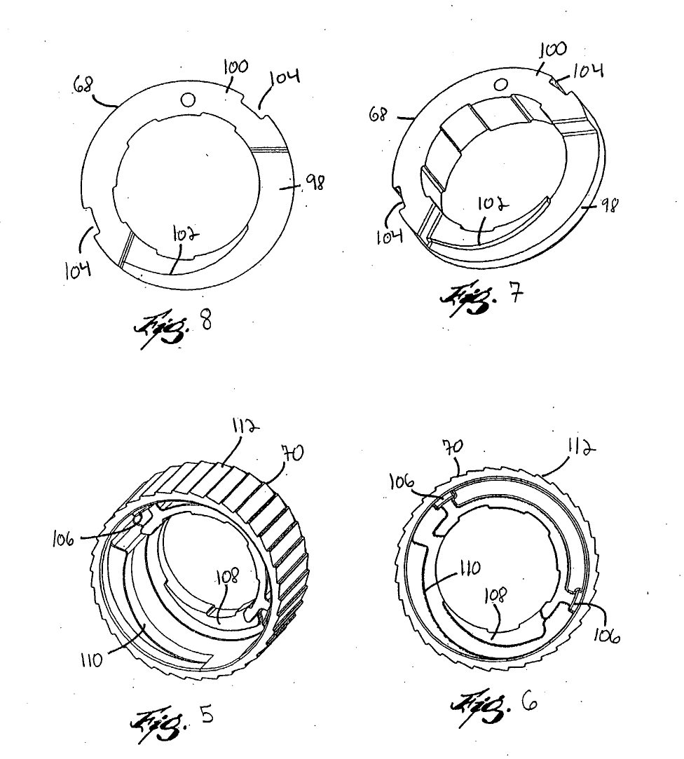

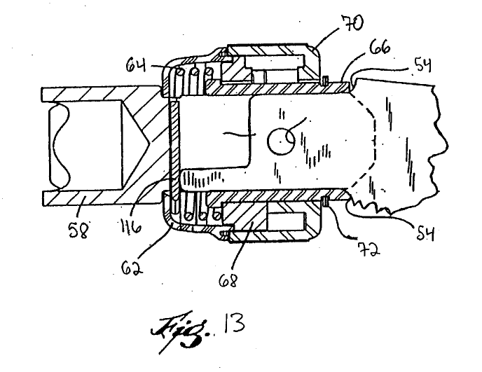

Referring to FIGS. 4-13, a first construction of the blade clamp assembly 18 is illustrated. The assembly 18 is mounted on a support 58 of the handle 12 and includes a pin 60, a spring cover 62, a spring 64, a sleeve 66, a rear cam member 68, a front cam member 70, and a retainer clip 72.

The support 58 includes a support tip 74 having a slot 76 dimensioned to receive the blade 20, and a tip orifice 78 extending laterally from an outer surface of the support tip 74 to the slot 76 (FIG. 4). The sleeve 66 is positioned around the support tip 74, and includes a cylindrical body portion 80 and a flange 82 (FIGS. 4 and 9-12). The inner diameter of the body portion 80 is dimensioned to receive the support tip 74. The body portion 80 includes a sleeve orifice 84 that is aligned with the support orifice 78.

The pin 60 is slidably positioned within the sleeve orifice 84 and the tip orifice 78. Referring specifically to FIG. 9, the pin 60 includes a cylindrical portion 86 and a conical portion 88 with a surface angled at about 45° relative to the surface of the cylindrical portion 86. The pin 60 further includes a head portion 90 that defines a shoulder 92 that facilitates lifting the pin 60, as described below. In the illustrated construction, the head portion 90 is square in cross section (FIG. 4). As shown in FIGS. 9-12, the support 58 further includes a drill point 94 in the form of a recess adapted to receive the end of the pin 60 if the pin 60 extends through the slot 76. This may occur, for example, when the pin 60 engages a blade 20 that is relatively thin.

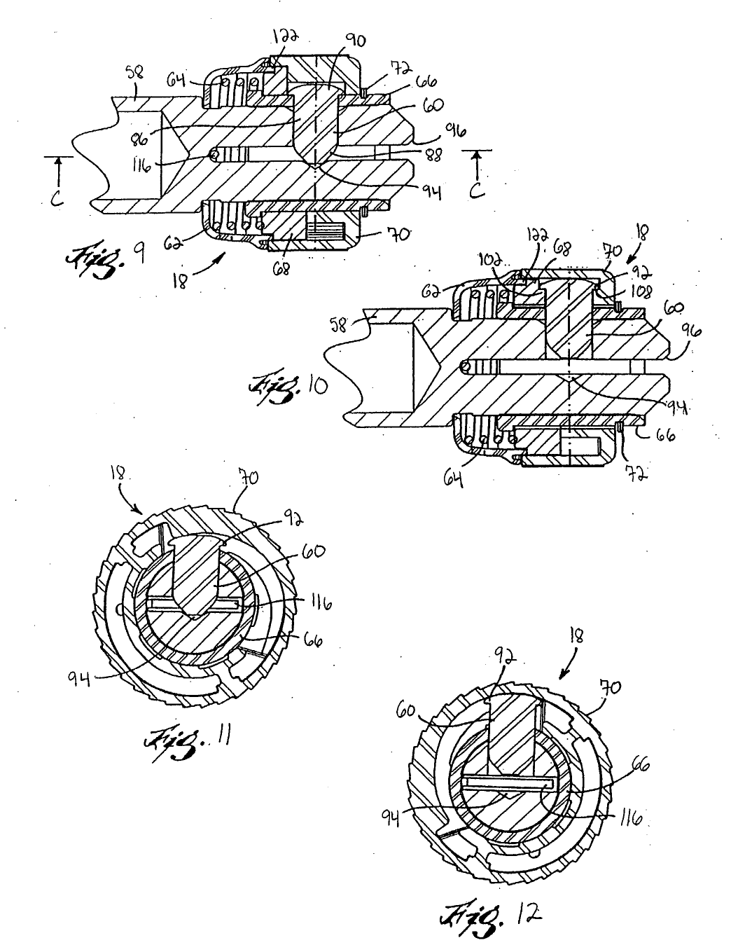

The support tip 74 extends axially beyond the end of the sleeve 66 (FIGS. 9 and 10). This may provide additional support to the blade 20, particularly forward of the tang 52, resulting in reduced blade breakage. In addition, the support tip 74 includes a chamfered or radiused tip 96. The chamfered or radiused tip 96 may also reduce blade breakage.

The rear cam member 68 is rotationally positioned over the sleeve 66. The flange 82 of the sleeve 66 limits axial movement of the rear cam member 68 in the rearward direction. Referring to FIGS. 4 and 7-8, the rear cam member 68 includes a base portion 98, a raised portion 100, and a rear cam surface 102. The rear cam surface 102 is positioned to act as an inner cam surface when it engages the shoulder 92 of the pin 60 to thereby facilitate movement of the pin 60 radially outward, as described below. Slots 104 are formed on the outer diameter of the rear cam member 68.

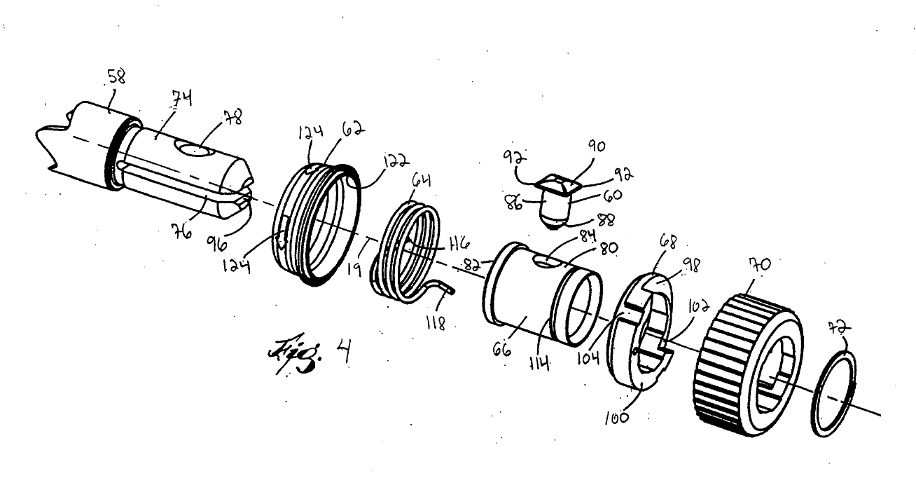

The front cam member 70 (FIGS. 5 and 6) is rotatably positioned over the sleeve 66 and in engagement with the rear cam member 68. In this regard, the raised portion 100 of the rear cam member 68 is positioned within the front cam member 70 such that the slots 104 engage splines 106 formed on the inner diameter of the front cam member 70. The front cam member 70 includes a front cam surface 108 in axially-spaced, opposing relation to the rear cam surface 102. Similar to the rear cam surface 102, the front cam surface 108 is positioned to act as an inner cam surface when it engages the shoulder 92 of the pin 60 to thereby facilitate movement of the pin 60 radially outward. The front and rear cam surfaces 102, 108 provide balanced forces on the pin 60 (FIG. 10).

The front cam member 70 further includes an outer cam surface 110 positioned radially outward from the pin 60. The outer cam surface 110 cooperates with the pin 60 to selectively move the pin 60 inward toward the slot 76 to engage the blade 20, as described below in more detail. The outer cam surface 110 radially cams the outer surface of the head portion 90 at the same rate as the inner cam surfaces 102, 108 to facilitate smooth movement of the pin 60.

In the illustrated construction, the front cam member 70 is provided with an outer gripping surface 112 having a unidirectional pattern in the rotational direction (FIGS. 5-6 and 11-12). That is, the pattern on the gripping surface 112 provides greater friction to a user's hand when attempting to rotate in one direction compared to the opposite direction. For example, in the illustrated construction, the pattern involves a series of repeating ramps that have different ramp angles. In this construction, the friction encountered when rotating the assembly 18 from a static, engaged condition to the released condition is greater than the friction that would be encountered if the user were to try to rotate the assembly 18 in the opposite direction. This may reduce the chance of damage that may be caused by forcing the assembly 18 to turn in the wrong direction. The retainer clip 72 engages a groove 114 in the sleeve 66 to retain the entire assembled assembly 18 mounted on the tip of the support tip 74 (FIGS. 4 and 9-10).

The rear and front cam members 68, 70 are collectively rotatable relative to the support 58 between an engaged position (FIGS. 9 and 11), in which the pin 60 is forced toward the slot 76, and a disengaged position (FIGS. 10 and 12), in which the pin 60 is forced away from the slot 76. In this way, the rear and front cam members 68, 70 constitute a construction of an actuating member that is operatively associated with the pin 60, which constitutes a locking member.

The spring 64 (FIGS. 4 and 9-12) is positioned to the rear of the rear cam member 68. The spring 64 includes a rear leg 116 positioned within the slot 76, and a front leg 118 positioned within an orifice 120 in the rear cam member 68. The spring 64 is thereby interconnected with the rear cam member 68 for biasing the blade clamp assembly 18. The spring 64 constitutes a construction of a biasing member and is positioned to bias the actuating member (e.g., the rear and front cam members 68, 70) toward the engaged position.

The spring cover 62 (FIGS. 4 and 9-12) is rotatably positioned over the support tip 74. The spring cover 62 encloses a substantial portion of the spring 64, and thereby prevents outside contaminants from entering the spring 64 and affecting the action of the spring 64. Contaminants, such as bits of material thrown off by the hand saw 10, between the coils of the spring 64 could prevent proper action of the spring 64. The spring cover 62 includes a front lip 122 that fits within the inner edge of the front cam member 70. The spring cover 62 can further include markings (e.g., arrows 124) that indicate the proper direction for rotation of the assembly 18 to the disengaged condition. The arrows 124 can also indicate the proper direction of rotation of the assembly 18 to the engaged condition.

In operation, before a blade 20 is inserted, the rear and front cam members 68, 70 are normally in the engaged position due to the biasing action of the spring 64. To insert a blade 20, cam member 70 is engaged by the user and rotated, along with the rear cam member 68, to the released position, which engages the inner cam surfaces with the shoulder of the pin 60 and forces the pin 60 to move out of the slot 76. The tang 52 of the blade 20 is then inserted into the slot 76 until the shoulder portions 54 of the blade 20 contact the sleeve 66. The rear and front cam members 68, 70 are then allowed to rotate back to the engaged position due to the biasing force of the spring 64. When moving from the released position to the engaged position, the outer cam surface 110 of the front cam member 70 forces the pin 60 to move into the aperture 56 in the blade 20, thereby causing the blade 20 to be fixedly clamped by the assembly 18.

When a blade 20 is inserted into the slot 76, the shoulder portions 54 will engage the sleeve 66 at two locations. The pin 60 is insertable into the aperture 56 defined through the tang 52 of the blade 20 to facilitate engagement of the blade 20 to the handle 12.

In other constructions (not shown), insertion of the blade 20 may overcome the biasing force of the spring 64 to move the pin 60 and allow the blade 20 to fully-insert into the slot 76. The biasing force of the spring 64 would then move the pin 60 into the aperture 56 of the tang 52 (the locked position).

The blade 20 is released by rotating the rear and front cam members 68, 70 against the biasing force of the spring 64. This forces the pin 60 to move out of the slot 76, thereby allowing the blade 20 to be pulled from the slot 76.

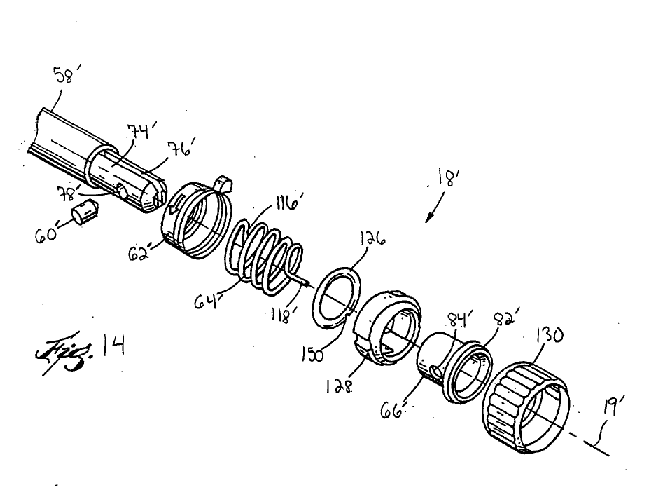

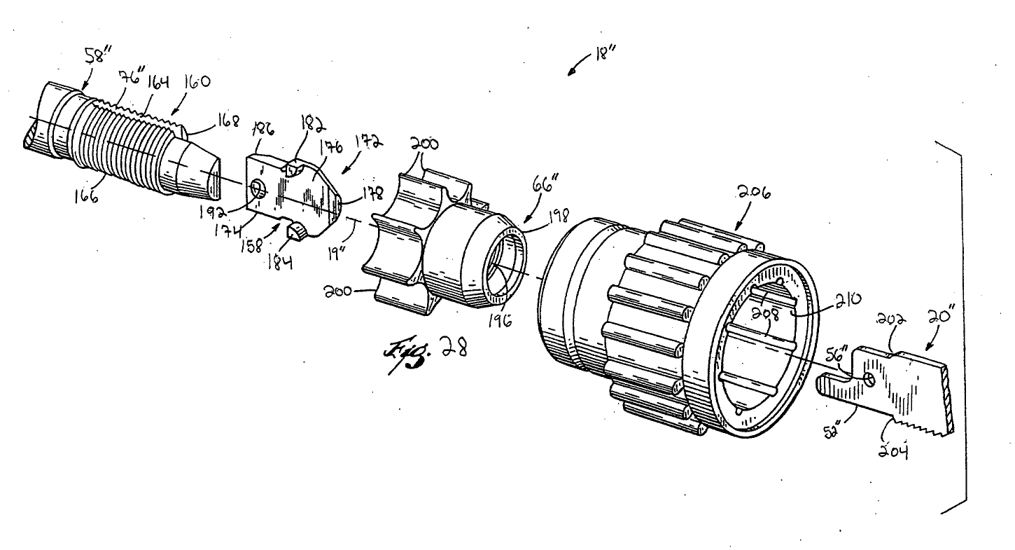

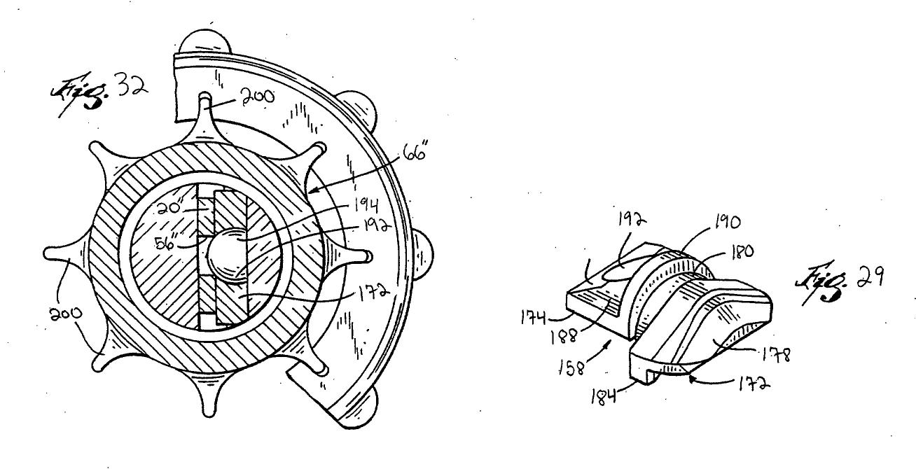

Referring to FIGS. 14-27, a second construction of the blade clamp assembly 18 is illustrated. Common elements are identified by the same reference numbers “′”.

The assembly 18′ is mounted on the support 58′ of the handle 12′ and includes a pin 60′, a spring cover 62′, a spring 64′, a washer 126, a cam collar 128, a sleeve 66′ and a collar housing 130.

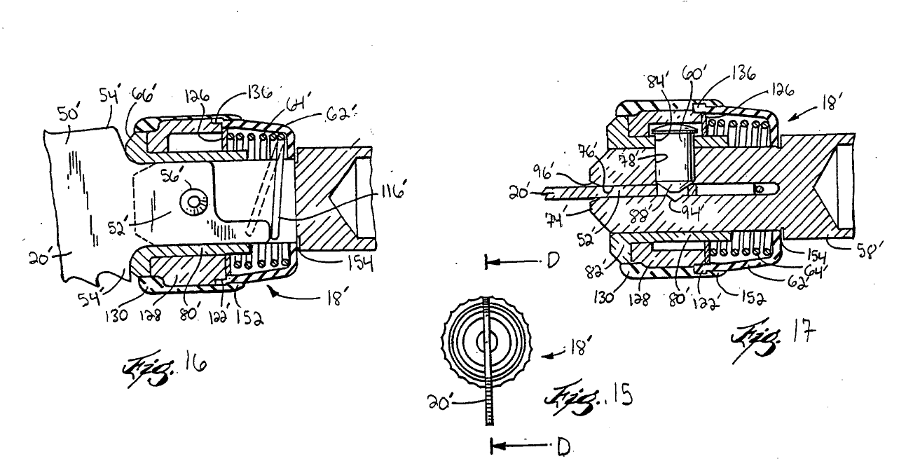

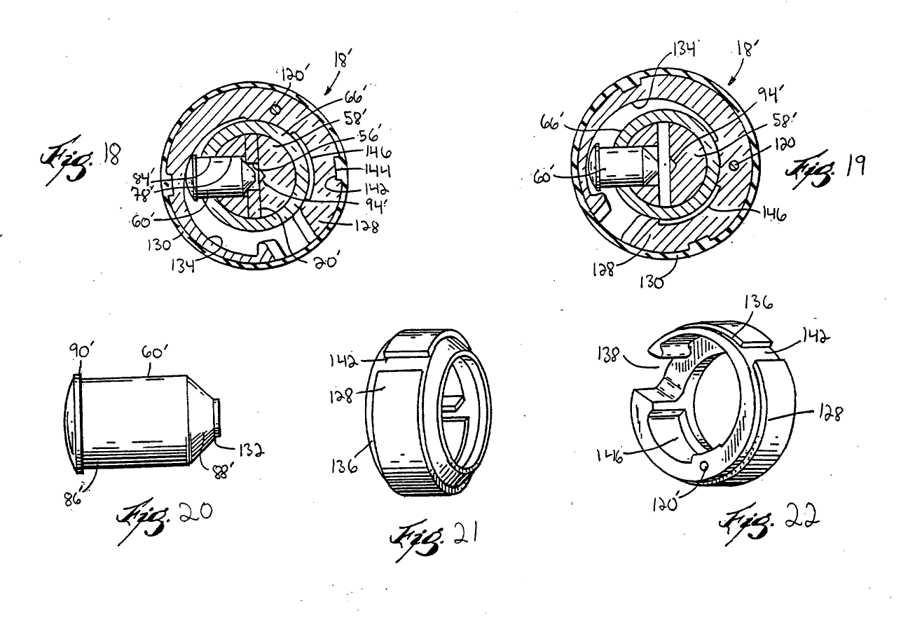

The pin 60′ (FIGS. 14 and 16-20) is slidably positioned within the sleeve orifice 84′ and the tip orifice 78′. Referring specifically to FIG. 20, the pin 60′ includes a cylindrical portion 86′ and a conical portion 88′ with a surface angled at about 45° relative to the surface of the cylindrical portion 86′. The conical portion 88′ includes a tip 132 that is angled at about 40° relative to the surface of the cylindrical portion 86′. The pin 60′ further includes a head portion 90′ that limits inward movement of the pin 60′ relative to the sleeve 66′. The head portion 90′ includes a curved outer surface that contacts the cam collar 128. As shown in FIG. 17, the support 58′ further includes a drill point 94′. The drill point 94′ is a recess adapted to receive the end of the pin 60′ if the pin 60′ extends through the slot 76′. This may occur, for example, when the pin 60′ engages a blade 20′ that is relatively thin.

As shown in FIG. 17, the support tip 74′ extends axially beyond the end of the sleeve 66′. This is believed to provide additional support to the blade 20′, particularly forward of the tang 52′, resulting in reduced blade breakage. In addition, the support tip 74′ includes a chamfered or radiused tip 96′. The chamfered or radiused tip 96′ is also believed to reduce blade breakage.

The cam collar 128 (FIGS. 18-19 and 21-22) is rotatably positioned over the sleeve 66′, and is thereby mounted on the end of the support 58′. The cam collar 128 includes a radial camming surface 134 that cooperates with the pin 60′ to selectively move the pin 60′ toward the slot 76′ to engage the blade 20′, as described below in more detail. The cam collar 128 is rotatable relative to the support 58′ between an engaged position (FIG. 18), where the pin 60′ is forced toward the slot 76′, and a disengaged position (FIG. 19), where the pin 60′ is free to move out of the slot 76′. In this way, the cam collar 128 constitutes a construction of an actuating member that is operatively associated with a locking member, here shown as the pin 60′.

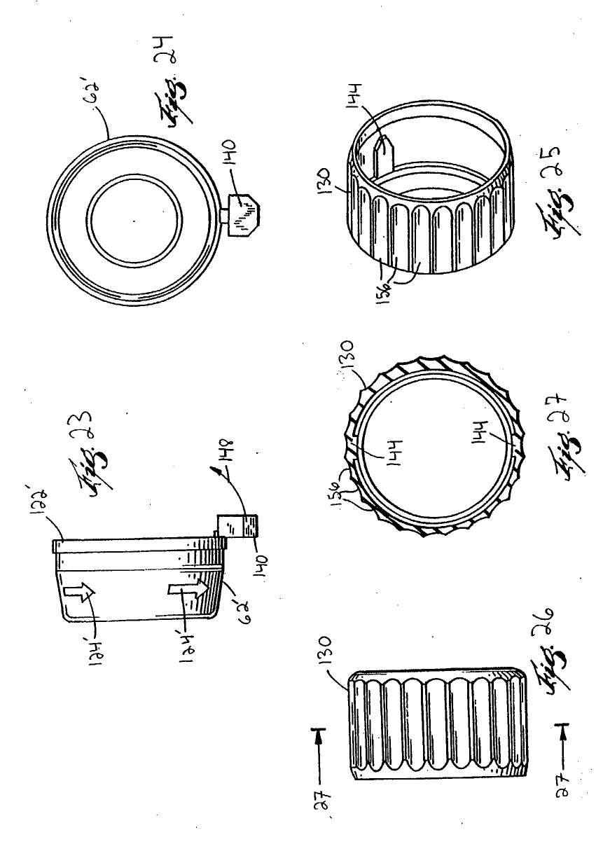

The cam collar 128 further includes a recessed outer edge 136 that cooperates with the front edge 122 of the spring cover 62′ (FIGS. 16 and 17). A recess 138 in the cam collar 128 (FIG. 22) cooperates with a tab member (e.g. tab 140) on the spring cover 62′ (FIGS. 23 and 24). The recess 138 facilitates insertion of the pin 60′ during assembly, as described below in more detail. Two opposed longitudinal grooves 142 on the outer surface of the cam collar 128 facilitate engagement of the cam collar 128 with splines 144 on the inner surface of the collar housing 130 (FIGS. 18, 25 and 27). The cam collar 128 further includes a cam collar pocket 146 that may collect contaminants during use.

The spring cover 62′ (FIGS. 14, 16-17 and 23-24) is rotatably positioned over the support tip 74′. The spring cover 62′ encloses a substantial portion of the spring 64′, and thereby prevents outside contaminants from entering the spring 64′ and affecting the action of the spring 64′. Contaminants, such as bits of material thrown off by the hand saw 10′, between the coils of the spring 64′ could prevent proper action of the spring 64′. Additionally, as noted above, the front edge 122 of the spring cover 62′ fits around the recessed outer edge 136 of the cam collar 128. The spring cover 62′ thereby forms an labyrinth seal with the cam collar 128. Further, the collar housing 130 shields the junction of the spring cover 62′ and the cam collar 128.

The tab 140 on the spring cover 62′ fits within the recess 138 in the cam collar 128. More specifically, during assembly, the tab 140 is designed to be bent in the direction of the arrow 148 (FIG. 23) until the tab 140 is positioned within the recess 138 in the cam collar 128 (FIG. 22) as described below in more detail. The outer surface of the spring cover 62′ includes a plurality of arrows 124 that provide a visual indication of the direction the clamp is designed to be turned.

The spring 64′ (FIGS. 14 and 16-17) is positioned between the cam collar 128 and the spring cover 62′. The spring 64′ includes a rear leg 116′ positioned within the slot 76′, and a front leg 118′ positioned within an orifice 120′ in the cam collar 128. The spring 64′ is thereby interconnected with the cam collar 128 for biasing the cam collar. The spring 64′ constitutes a construction of a biasing member and is positioned to bias the cam collar 128 toward the engaged position.

In addition to providing a rotational bias function, the positioning of a portion of the spring 64′, the rear leg 116′, in the slot 76′ also provides an ejection mechanism for automatically ejecting the blade 20′ upon rotation of the cam collar 128 to the released position. More specifically, when the blade 20′ is fully inserted into the slot 76′, the tang 52′ will contact the rear leg 116′, and the rear leg 116′ will be deflected (FIG. 16). The initial and deflected positions of the rear leg 116′ are shown in FIG. 16 in dashed and solid lines, respectively. The deflection of the spring 64′ provides an axial force that will urge the blade 20′ from the slot 76′ when the engagement of the clamp with the blade 20′ is released. In this way, the rear leg 116′ of the spring 64′ constitutes a construction of an ejecting member. This feature is particularly advantageous when the body portion 50′ has broken away from the tang 52′.

The washer 126 (FIGS. 14 and 16-17) is positioned between the spring 64′ and the cam collar 128. The washer 126 includes a notch 150 for accommodating the front leg 118′ of the spring 64′. The washer 126 provides a contaminant barrier to prevent debris from entering the cam collar 128 and disturbing the interaction between the camming surface 134 and the pin 60′. In addition, the washer 126 prevents the tab 140 from entering the spring cover 62′ and obstructing the operation of the spring 64′.

The spring 64′ is a spaced torsion spring (i.e., there is space between the coils) that can be compressed from its unloaded length. This compression of the spring 64′ is used to bias the washer 126 into the engagement with the cam collar 128, thereby preventing the washer 126 from rattling around inside the assembly 18′.

The collar housing 130 (FIGS. 14, 16-17 and 25-27) is positioned over both the cam collar 128 and engages the front edge 122′ of the spring cover 62′. The collar housing 130 further includes a clip portion 152 that snaps over the front edge 122′ of the spring cover 62′, to hold the spring cover 62′ and the cam collar 128 in sealing engagement. Because the collar housing 130 is held forward by engagement with the front side of the cam collar 128, the collar housing 130 thereby holds the spring cover 62′ forward also. The collar housing 130 thereby performs the additional function of holding the spring cover 62′ away from the support 58′ to reduce frictional engagement of the spring cover 62′ with the support 58′. To aid in reducing frictional engagement of the spring cover 62′ with the support 58′, a gap 154 is left between the spring cover 62′ and the support 58′. The collar housing 130 includes a plurality of arcuate recesses 156 that facilitate engagement of the collar housing 130 by a user's hand or fingers. As noted above, the collar housing 130 also includes two opposing splines 144 that are dimensioned to engage corresponding grooves 142 in the cam collar 128, and thereby ensure that rotation of the collar housing 130 results in rotation of the cam collar 128.

The collar housing 130 performs the additional function of thermally insulating the user's hand or fingers from the heat of the blade 20′, blade clamp assembly 18′, and support 58′. Due in part to friction, various components of the hand saw 10′ can heat up during use. If the collar housing 130 is made of plastic or other thermally insulative materials, an uncomfortable condition for the user can be prevented.

When the blade 20′ is inserted into the slot 76′, the shoulder portions 54′ will engage the sleeve 66′ at two locations. The pin 60′ is insertable into the aperture 56′ defined through the tang 52′ of the blade to facilitate engagement of the blade 20′ to the handle 12′. In this regard, the positioning of the pin 60′ relative to the end of the sleeve 66′ is such that the blade 20′ will be held in a three-point mount between the aperture 56′ and the two shoulder portions 54′. More specifically, when the shoulder portions 54′ contact the sleeve 66′ and the pin 60′ is radially advanced toward the aperture 56′ in the blade 20′, the pin 60′ will contact the rear edge of the aperture 56′ (i.e., the edge away from the shoulder portions 54′). Due to the conical portions 88′ of the pin 60′, such contact of the pin 60′ with the rear edge of the aperture 56′ will cause the blade 20′ to be pulled rearwardly, resulting in the shoulder portions 54′ being tightened against the sleeve 66′. This results in a three-point mount between the rear edge of the aperture 56′ and the two shoulder portions 54′.

In operation, before a blade 20′ is inserted, the cam collar 128 is normally in the engaged position due to the biasing action of the spring 64′. To insert a blade 20′, the collar housing 130 is engaged by the user and rotated to the released position, thereby allowing the pin 60′ to move out of the slot 76′. The tang 52′ of the blade 20′ is then inserted into the slot 76′ until the shoulder portions 54′ of the blade 20′ contact the sleeve 66′. At this point, the aperture 56′ in the blade 20′ is slightly misaligned with the pin 60′. The cam collar 128 is then allowed to rotate back to the engaged position due to the biasing force of the spring 64′. When moving from the released position to the engaged position, the radial camming surface 134 of the cam collar 128 forces the pin 60′ toward the slot 76′. Because of the misalignment of the pin 60′ with the aperture 56′ in the blade 20′, the pin 60′ contacts the rear edge of the aperture 56′, thereby causing the blade 20′ to be pulled slightly rearwardly and fixedly clamped by the assembly 18′.

In other constructions (not shown), insertion of the blade 20′ may overcome the biasing force of the spring 64′ to move the pin 60′ and allow the blade 20′ to fully-insert into the slot 76′. The biasing force of the spring 64 would then move the pin 60 into the aperture 56′ of the tang 52′ (the locked position).

The blade 20′ is released by rotating the cam collar 128 against the biasing force of the spring 64′. This allows the pin 60′ to move out of the slot 76′, thereby allowing the blade 20′ to be pulled from the slot 76′.

The above-described blade clamp assembly 18′ can be assembled in the following manner. Referring to FIG. 14, the spring cover 62′ and spring 64′ are installed on the support 58′ with the rear leg 116′ of the spring 64′ positioned within the slot 76′ of the support 58′. The washer 126 is then slid over the support 58′ such that the notch 150 in the washer 126 receives the front leg 118′ of the spring 64′. Next, the cam collar 128 is positioned onto the support 58′ such that the orifice 120′ receives the front leg 118′ of the spring 64′. The sleeve 66′ is then slid onto the support 58′ and the spring 64′ is compressed until the sleeve orifice 84′ is aligned with the tip orifice 78′. Next, the cam collar 128 is aligned relative to the support by rotating the cam collar 128 in the direction of the arrows 124 until the recess 138 is aligned with the sleeve orifice 84′ and thereby aligned with the tip orifice 78′. The pin 60′ is then inserted through the recess 138, sleeve orifice 84′, and the tip orifice 78′. The cam collar 128 is then released. The tab 140 is then moved, such as by bending the tab 140 about 90°, into the recess 138. The tab 140 will help prevent the pin 60′ from moving back into the recess 138. Finally, the collar housing 130 is slid over the cam collar 128 such that the splines 144 in the collar housing 130 engage the grooves 142 on the cam collar 128 until the collar housing 130 snaps onto the spring cover to hold the assembly 18′ in place as a unit.

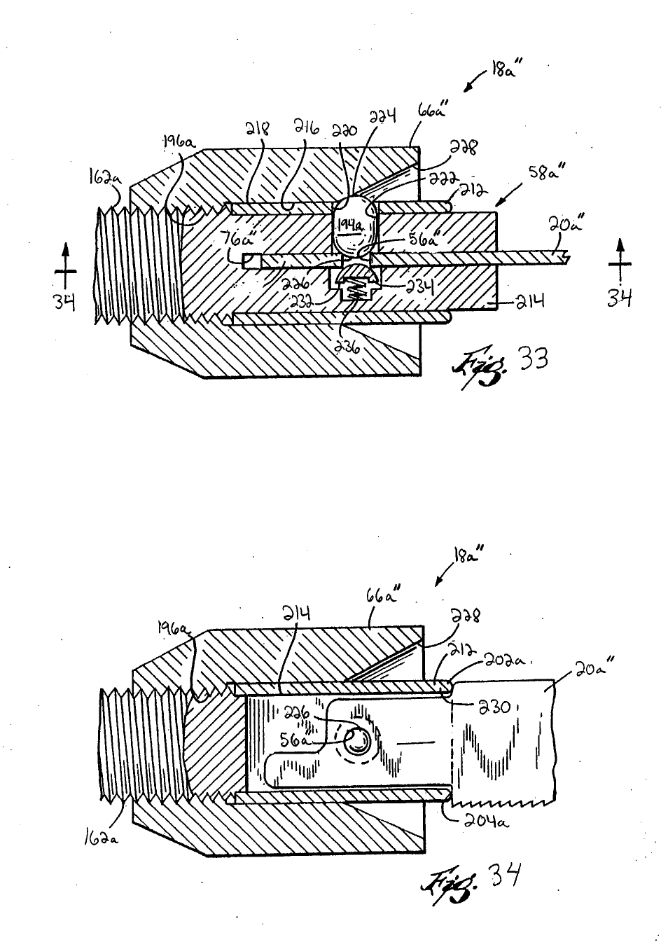

Referring to FIGS. 28-32, a third construction of the blade clamp assembly 18″ is illustrated. Common elements are identified by the same reference numbers “″”.

The assembly 18″ is mounted on the support of the handle 12″ and includes a metallic clamping member 158 for securing the blade 20″ to the support 58″ and a sleeve 66″ threadably received on the support 58″ for forcing the clamping member 158 against the blade 20″ and the support 58″ thereby securing the blade 20″ to the support 58″.

The support 58″ is an elongate shaft member having one end constructed and arranged for being secured to the handle 12″. The opposite end 160 of the support has external threads 162 and an axially extending slot 76″ for receiving the tang 52″ of the blade 20″. The slot 76″ is offset relative to the axis of support 58″ and divides the end 160 into left and right portions 164 and 166. An inclined surface 168 is formed in the forward portion 164 of support 58″ and intersects the slot 76″ intermediate its ends and extends outwardly therefrom. The opposite side of the slot 76″ is defined by a generally planar surface 170.

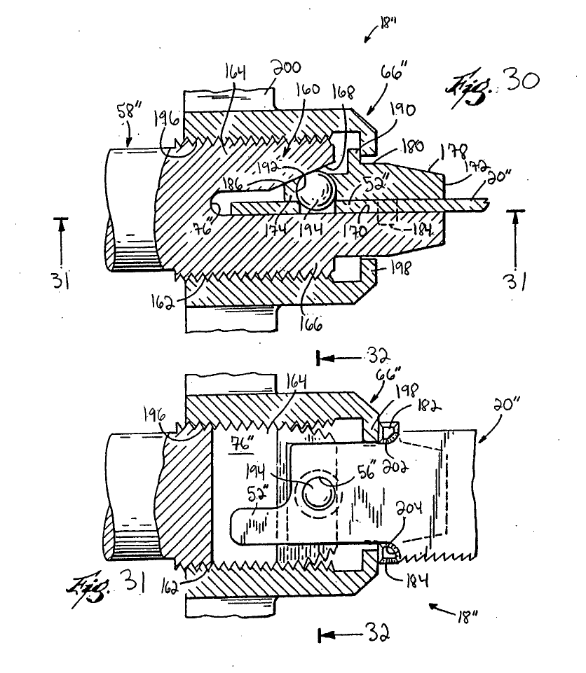

The clamping member 158 has a forward nose portion 172 and a rear wedge portion 174. The surface 176 of member 158 is generally planar while the opposite surface (FIG. 29) of the nose portion 172 includes a section of a frusto-cone 178 and a short cylindrical section 180. At the sides of the surface 176 and adjacent the junction of the sections 178 and 180, there are a pair of extending ears 182 and 184.

The wedge portion 174 includes a surface 186 which is inclined relative to the planar surface 176 at the same angle that the surface 168 in support 58″ is inclined relative to the axis of the slot 76″. Inwardly of the inclined slot there is an axially extending surface 188, and a laterally extending flange 190 disposed between the nose portion 172 and the wedge portion 174. A recess 192 is formed in the wedge portion 174 for housing a metallic ball or engaging member 194 which is suitably fixed within recess 192 so that only a portion extends from the surface 176 (FIG. 30), that extending portion of the ball functioning to engage the aperture 56″ in the blade 20″ as will be described. The opposite portion of the ball 194 (as seen in FIG. 30) is ground to conform to the contours of the surfaces 186 and 192. Instead of a ball 194, a section of a sphere could also be formed on surface 176 and project therefrom in the same manner as ball 194. In other constructions, the ball 194 could be replaced by a member having a conical projection for engaging the hole in the blade, or the ball 194 could be replaced by a pin or projection having other configurations.

The sleeve 66″ is a generally tubular member having internal threads 196 which are complementary to the threads 162 formed on the end 160 of the support 58″. The threads 196 extend from a first end of sleeve 66″ to a point short of the opposite end which has an inwardly extending rim 198 formed thereon. A plurality of radially extending fins 200 project radially outwardly from the sleeve 66″ adjacent the first end.

As best shown in FIG. 31, the ears 182 and 184 on clamping member 158 are spaced apart from each other and from the ball 194 such that the ears 182 and 184 engage the upper and lower shoulders 202 and 204. The surface of the engaging member 194 engages the rearward edge of the aperture 56″ in the tang 52″ of the blade 20″. In the case where the tang 52″ only has a single shoulder 204, the ear 182 engages the upper edge of the tang 52″.

The clamping member 158 is disposed adjacent the slot 76″ with its inclined surface 186 facing the inclined surface 168. In addition, the sleeve 66″ is threaded onto the support 58″ with the rim 198 surrounding the cylindrical section 180 of member 158 and engaging the flange 190. When the tang 52″ of blade 20″ is inserted into the slot 76″, it moves between the surfaces 170 and 176 until the shoulders 202 and 204 engage the ears 182 and 184. At this point, the engaging member 194 engages the rearward rim of aperture 56″. The sleeve 66″ may then be tightened to force the clamping member 158 into the slot 76″ and to force the surface 186 of clamping member 158 against the surface 168 of support 58″. This forces the engaging member 194 against the back of aperture 56″ so that the blade 20″ is urged inwardly toward the saw 10″ and the shoulders 202 and 204 are forced against the ears 182 and 184 to provide a rigid three point support for the blade 20″. In addition, the nose portion 178 of the clamping member 158 extends past the inner end of tang 52″ and onto the blade 20″ to prevent the blade 20″ from flexing at the intersection with tang 52″ thereby reducing the possibility of blade failure at what is otherwise its weakest point. The ears 182 and 184 and the engaging member 194 are also arranged such that the blade 20″ tilts downwardly at a slight angle to facilitate cutting at a downward angle. A guide 206 is preferably a tubular member having longitudinal slots 208 on its inner surface 210 for receiving the fins 200. This facilitates the tightening of the sleeve 66″ and protects the operator from the reciprocating fins 200.

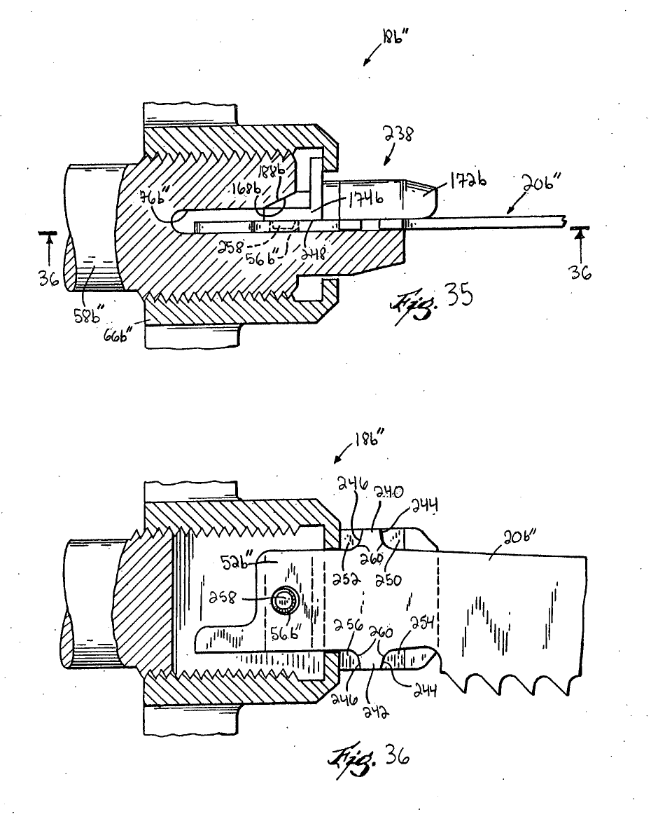

Referring to FIGS. 33 and 34, a fourth construction of the blade clamp assembly 18a″ is illustrated. The fourth construction is similar to the third construction of the blade clamp assembly 18″ and will be discussed with respect to the differences therebetween. Common elements are identified by the same reference numbers “a”.

The blade clamp assembly 18a″ includes the support 58a″, a collar 66a″, and a sleeve 212 disposed therebetween. The support 58a″ has an unthreaded end 214, external threads 162a adjacent the unthreaded end 214 and an axial slot 76a″ which extends through the unthreaded end portion. The sleeve 212 surrounds the unthreaded end 214 of support 58a″ and the slot 76a″. The collar 66a″ has internal threads 196a at one end which are complementary to the threads 162a of the support 58a″. The remaining portion of the inner surface 216 of collar 66a″ is unthreaded and surrounds the outer surface 218 of sleeve 212.

Aligned holes 220 and 222 are formed in this sleeve 212 and the support 58a″, respectively, for receiving an engaging member or detent 194a having engaging surfaces 224 and 226 at its ends, respectively. The collar 66a″ has an outwardly facing, frusto-conical internal surface 228 at its end opposite the threads 196a and which engages the outer spherical surface 224 of engaging member 194a. The engaging member 194a is positioned such that when a blade 20a″ is in the slot 76a″, the aperture 56a″ in the blade tang 52a″ is adjacent the engaging member 194a.

Upon tightening, the collar 66a″ moves to the right as viewed in FIG. 33 thereby forcing the end 226 of engaging member 194a against the rearward rim of the aperture 56a″ in blade tang 52a″. The aperture 56a″ is offset relative to engaging member 194a so that the engaging member 194a engages the rear edge of the aperture 56a″. This forces the blade 20a″ toward the handle 12a″ thereby forcing the shoulders 202a and 204a into engagement with the outer edge 230 of the sleeve 212 to provide a firm three point support. The edge 230 is preferably arcuate for engagement with the complementary surface of the shoulders 202a and 204a.

A second detent 232 may be disposed in a counter sunk hole 234 formed in support 58a″ in alignment with the hole 222. A spring 236 urges the detent 232 into the aperture 56a″ on the side of tang 52a″ opposite the engaging member 194a.

Referring to FIGS. 35 and 36, a fifth construction of the blade clamp assembly 18b″ is illustrated. The fifth construction is similar to the third construction of the blade clamp assembly 18″ and will be discussed with respect to the differences therebetween. Common elements are identified by the same reference numbers “b”.

The blade clamp assembly 18b″ includes a clamp member 238 constructed and arranged to be employed with a blade 20b″ having a modified tang 52b″. In particular, the tang 52b″ includes relatively smaller tangs 240 and 242 extending laterally from its opposite sides. Each tang 240 and 242 has forward and rear arcuate edges 244 and 246, respectively, with the edges 244 and 246 converging toward the projecting ends of the tangs 240 and 242. In addition, an aperture 56b″, is formed in the tang 52b″ rearwardly of the tangs 240 and 242.

The clamping member 238 is similar to that shown in the third construction of the blade clamp assembly 18″ and, more particularly, in FIGS. 28-32. The clamping member 238 includes a rear wedge portion 174b having an inclined surface 188b and a front nose portion 172b. The surface 248 of the clamping member 238 on the side opposite the inclined surface 188b is generally planar for engaging the tang 52b″. A pair of spaced apart ears 250 and 252 extend from the surface 248 and intermediate the ends of the nose portion 172b and are intended to be positioned on opposite sides of the tang 240. A second pair of ears 254 and 256 project from the surface 248 and are intended to be positioned on opposite sides of the tang 242. In addition, an engaging member 258 having the shape of a truncated cone extends outwardly from the surface 248 opposite the wedge portion 174b and is intended to be housed in the aperture 56b″. Each of the ears 250, 252, 254, 256 has an arcuate surface 260 which is complementary with the opposed surface of the tangs 240 and 242. In addition, the ears 252 and 256 and the engaging member 258 are spaced from each other such that when the conical surface of the engaging member 258 engages the rearward edge of the aperture 56b″, the surfaces 260 of ears 252 and 256 engage the edges of the tangs 240 and 242.

The support 58b″ and the sleeve 66b″ are similar to the corresponding parts of the third construction of FIGS. 28-32. When the tang 52b″ of blade 20b″ is inserted into the slot 76b″ formed in support 58b″, and between the clamping member 238 and the surface 168b of support 58b″ so that the aperture 56b″ is moved into a position opposite the engaging member 258, the tangs 240 and 242 are positioned between the ears 250, 252, 254, 256 respectively with the surfaces 260 opposed to the tangs 240 and 242. The sleeve 66b″ may then be tightened to force the inclined surface 188b on the clamping member 238 against the complementary inclined surface 168b on the support 58b″. This forces the engaging member 258 against the rear edge of the aperture 56b″ and the surfaces 260 on ears 252 and 256 into engagement with the tangs 240 and 242. As a result, the blade 20b″ is urged inwardly of the support 58b″ and firmly locked in position.

Although particular constructions of the present invention have been shown and described, other alternative constructions will be apparent to those skilled in the art and are within the intended scope of the present invention. Thus, the present invention is to be limited only by the claims.

One or more independent features and independent advantages of the present invention are set forth in the following claims:

I claim:

1. A manual hand saw comprising:
a handle;
a quick release blade clamp assembly connected to the handle and adapted to selectively attach a blade to the handle.

2. The hand saw as claimed in claim 1, wherein the blade clamp assembly includes
a locking member movable relative to the handle between a locked position, in which the locking member engages the blade, and an unlocked position, in which the locking member does not engage the blade, and
an actuating member operatively associated with the locking member and movable relative to the handle between an engaged position, in which the locking member is in the locked position, and a disengaged position, in which the locking member is in the unlocked position.

3. The hand saw as claimed in claim 2, wherein the actuating member is rotatable relative to the handle between the engaged position and the disengaged position.

4. The hand saw as claimed in claim 2, wherein the actuating member allows the locking member to move from the locked position to the unlocked position when the actuating member is moved from the engaged position to the disengaged position.

5. The hand saw as claimed in claim 2, wherein the actuating member moves the locking member from the locked position to the unlocked position when the actuating member is moved from the engaged position to the disengaged position.

6. The hand saw as claimed in claim 2, wherein the actuating member moves the locking member from the unlocked position to the locked position when the actuating member is moved from the disengaged position to the engaged position.

7. The hand saw as claimed in claim 2, wherein the actuating member allows the locking member to move from the unlocked position to the locked position when the actuating member is moved from the disengaged position to the engaged position.

8. The hand saw as claimed in claim 2, wherein the blade clamp assembly further includes a biasing member interconnected with the actuating member for biasing the actuating member toward the engaged position.

9. The hand saw as claimed in claim 8, wherein the biasing member is a spring.

10. The hand saw as claimed in claim 9, wherein the biasing member is a torsional coil spring.

11. The hand saw as claimed in claim 8, wherein the blade clamp assembly further includes a washer positioned against a portion of the biasing member.

12. The hand saw as claimed in claim 8, wherein the blade clamp assembly further includes a cover enclosing a substantial portion of the biasing member, and wherein the actuating member engages the cover to form a seal.

13. The hand saw as claimed in claim 8, wherein the blade clamp assembly further includes a cover enclosing a substantial portion of the biasing member and a housing enclosing a substantial portion of the actuating member, the housing engaging the cover to form a seal, and wherein the actuating member engages the cover at a junction and the housing encloses at least part of the junction.

14. The hand saw as claimed in claim 1, wherein the blade clamp assembly includes
a locking member movable relative to the handle between a locked position, in which the locking member engages the blade, and an unlocked position, in which the locking member does not engage the blade, and
an actuating member operatively associated with the locking member and movable relative to the handle between an engaged position and a disengaged position, movement of the actuating member from the disengaged position to the engaged position resulting in forced movement of the locking member from the unlocked position to the locked position, and movement of the actuating member from the engaged position to the disengaged position resulting in forced movement of the locking member from the locked position to the unlocked position.

15. The hand saw as claimed in claim 14, wherein the hand saw defines a longitudinal axis, the actuating member being rotatable about the axis.

16. The hand saw as claimed in claim 14, wherein the actuating member includes an outer cam surface and an inner cam surface, and wherein the locking member includes an outer follower surface drivable by the outer cam surface and an inner follower surface drivable by the inner cam surface.

17. The reciprocating tool of claim 14, wherein the actuating member includes an outer gripping surface having a unidirectional pattern facilitating gripping and moving the actuating member toward the disengaged position.

18. The hand saw as claimed in claim 1, wherein the handle has a rear end and a front end and defines an opening extending from the rear end toward the front end.

19. The hand saw as claimed in claim 18, wherein threads are defined within the opening and are threadably engageable with complementary threads on a handle extension to connect the handle extension and the handle.

20. The hand saw as claimed in claim 1, wherein the handle defines threads, the threads being threadably engageable with complementary threads on a handle extension to connect the handle extension and the handle.

21. The hand saw as claimed in claim 20, wherein the handle includes a rear end and a front end and defines an opening extending from the rear end toward the front end, the threads of the handle being defined within the opening.

22. The hand saw as claimed in claim 1, wherein the blade is a reciprocating saw blade usable with a power-operated reciprocating saw.

23. The hand saw as claimed in claim 1, wherein the blade is a putty knife.

24. The hand saw as claimed in claim 1, wherein the blade is a carpet blade.

25. The hand saw as claimed in claim 1, wherein the blade is a file.

26. A manual hand saw comprising:
a handle having an outer surface and defining an opening extending from the outer surface, the opening having a first handle portion adjacent to the outer surface and having a first diameter and a second handle portion having a second diameter less than the first diameter, the handle being operable to support a blade; and
a handle extension having a first extension portion engageable with the first handle portion and a second extension portion engageable with the second handle portion, the handle being connectable to the handle extension.

27. The hand saw as claimed in claim 26, wherein threads are defined in at least the second handle portion of the opening, and wherein complementary threads are formed on at least the second extension portion of the handle extension.

28. The hand saw as claimed in claim 26, further comprising a quick release blade clamp assembly connected to the handle and adapted to selectively attach the blade to the handle.

29. The hand saw as claimed in claim 28, wherein the blade clamp assembly includes
a locking member movable relative to the handle between a locked position, in which the locking member engages the blade, and an unlocked position, in which the locking member does not engage the blade, and
an actuating member operatively associated with the locking member and movable relative to the handle between an engaged position, in which the locking member is in the locked position, and a disengaged position, in which the locking member is in the unlocked position.

30. The hand saw as claimed in claim 26, wherein the blade is one of a reciprocating saw blade usable with a power-operated reciprocating saw, a putty knife, a carpet blade, and a file.

31. A kit comprising:
a manual hand saw adapted to support a blade;
a reciprocating saw blade usable with a power-operated reciprocating saw;
a putty knife; and
a carpet blade;
wherein the reciprocating saw blade, the putty knife, and carpet blade are interchangeably connectable to the hand saw.

32. The kit as claimed in claim 31, wherein the hand saw includes a handle and a quick release blade clamp assembly connected to the handle for selectively attaching a blade.

33. The kit as claimed in claim 32, wherein the blade clamp assembly includes
a locking member movable relative to the handle between a locked position, in which the locking member engages one of the reciprocating saw blade, putty knife, and carpet blade, and an unlocked position, in which the locking member does not engage one of the reciprocating saw blade, putty knife, and carpet blade, and
an actuating member operatively associated with the locking member and movable relative to the handle between an engaged position, in which the locking member is in the locked position, and a disengaged position, in which the locking member is in the unlocked position.

34. The kit as claimed in claim 31, wherein the hand saw includes a handle having a rear end and a front end and defines an opening therein extending from the rear end toward the front end, and wherein threads are defined within the opening and are threadably engageable with complementary threads on a handle extension to connect the handle extension and the handle.

35. A kit comprising:
a manual hand saw adapted to support a blade;
a first blade selectively supportable by the hand saw, the first blade being a first type of blade; and
a second blade selectively supportable by the hand saw, the second blade being a second type of blade different than the first type of blade.

36. The kit of blades as claimed in claim 35, wherein the first type of blade is a reciprocating saw blade useable with a power-operated reciprocating saw, and the second type of blade is a putty knife.

37. The kit of blades as claimed in claim 35, wherein the first type of blade is a reciprocating saw blade useable with a power-operated reciprocating saw, and the second type of blade is a carpet blade.

38. The kit of blades as claimed in claim 35, wherein the first type of blade is a reciprocating saw blade useable with a power-operated reciprocating saw, and the second type of blade is a file.

39. The kit of blades as claimed in claim 35, wherein the first type of blade is a putty knife, and the second type of blade is a carpet blade.

40. The kit of blades as claimed in claim 35, wherein the first type of blade is a putty knife, and the second type of blade is a file.

41. The kit of blades as claimed in claim 35, wherein the first type of blade is a carpet blade, and the second type of blade is a file.
